(19) United States
(12) Patent Application Publication
(10) Pub. No.: US 2011/0212639 A1
(43) Pub. Date: Sep. 1, 2011

(54) Circuit card assembly connector and interconnection system

(76) Inventors: Jeffrey Paquette, Wakefield, MA (US); Scott R. Cheyne, Brookline, NH (US); Craig C. Lemmler, Medway, MA (US)

(21) Appl. No.: 12/660,421

(22) Filed: Feb. 26, 2010

(51) Int. Cl. H01R 13/15

(52) U.S. Cl. 439/260

(57) ABSTRACT

A circuit card assembly connector system includes a circuit card assembly and an edge connector including a set of resilient, spaced, conductive contacts electrically isolated from each other and extending from a surface of and over an edge of the circuit card assembly; an interconnection system for circuit card assemblies may include at least first and second circuit card assemblies, at least one having such an edge connector for interconnecting with a set of contacts of the other circuit card assembly.

### FIELD OF THE INVENTION

This invention relates to an improved circuit card assembly connector and interconnection system.

### BACKGROUND OF THE INVENTION

Interconnection and connection systems for circuit card assemblies e.g., panel arrays, PWB's, PCB's, daughter and mother boards are a constant challenge in the electronic packaging industry. The aim is always for an interconnection scheme that allows quick and easy serviceability while maintaining the smallest footprint. In one application, for example, interconnection of daughter boards on panel arrays for phased array radar the goals are: little or no tooling or fixturing for assembly; supplying increased power and logic signals to support dual polarization; meeting military shock and vibration specification; repeatable and predictable operation; low cost and no loss of panel thermal management. In pursuit of these goals many different approaches are used. The cable approach requires a support fixture, stiffening tools and guide rods and is labor intensive. The spring loaded approach variously employs pogo pins, RC spring probes and fuzz buttons (or CIN::APSE buttons). All require surface pads on the board to which they interconnect. Large board to board spacing makes aligning the connectors to the connector pads more difficult. This requires very tight tolerancing and large enough pitch between pads to prevent shorting. Surface pad interfaces can lack electrical repeatability due to the lack of a wiping interface and the slightest debris can cause opens when assembled. The footprint of this style interconnect is as large, if not larger than that of the smallest available commercial off-the-shelf (COTS) connector on the market. To achieve similar density of pads they must go to a three row style connector which is much more difficult to route to.

Current edge connector technology relies on surface mount or through hole components and requires substantial PWB area. There are no space advantages over other prior art technologies (6× larger than cable approach, 2× larger than spring pin approach).

The cable interconnect approach requires extensive assembly fixtures, process, and time to assemble and uses delicate connectors which are easily damaged. It is expensive and currently there is only one supplier. There are no positive retention features (jack screws, etc.). Many perforations are required in the thermal heat sink restricting coolant flow and thermal spreading.

The spring loaded interconnect approach requires a larger footprint area on the board than the cable approach. Tolerance issues due to board to board spacing increase pad diameter and pitch. There is higher contact resistance because compression contact is not a good as a wiping contact and there is the risk of open circuits due to foreign object debris.

### SUMMARY OF THE INVENTION

In accordance with various aspects of the subject invention in at least one embodiment the invention presents an improved circuit card assembly connector and interconnection system which does not require any top side (component or MMIC populated area) surface, is low cost, simple to assemble and service, allows for higher density connection and has positive retention features.

In general overview, there is an improved circuit card assembly connector and interconnection system that in various aspects, can be achieved by a circuit card assembly connector and interconnection system which uses a circuit card assembly and an edge connector including a set of resilient, spaced, conductive contacts electrically isolated from each other and extending from a surface of and over an edge of the circuit card assembly.

The subject invention, however, in other embodiments, need not achieve all these objectives and the claims hereof should not be limited to structures or methods capable of achieving these objectives.

In one embodiment there is a interconnection system for circuit card assemblies including at least first and second circuit card assemblies, the first one having an edge connector including a set of resilient, spaced, conductive contacts electrically isolated from each other and extending from a surface of the first circuit card assembly and over the edge of the first circuit card assembly disposed opposite to a second set of conductive contacts on the edge of the second circuit card assembly.

In preferred embodiments the edge connector may include a header for mounting the contacts to the circuit card assembly. The contacts of the one circuit card assembly may directly interconnect with the contacts of the other circuit card assembly. There may be a connector card interposed between the circuit card assemblies which interconnects with the contacts of each of the circuit card assemblies. The connector card may include a connector apparatus with a positive retention device. The first circuit card assembly may carry electronic components on one surface and the contacts may extend from the other surface. Each first circuit card assembly may carry electronic components on one surface and the contacts may extend from that surface. The first set of contacts may be curved spring fingers. The first circuit card assembly may have a relief for accommodating the spring fingers. The second set of contacts may be curved spring fingers. The circuit card assemblies may be adjacent and constrained to apply a contact closing force to the contacts.

In another embodiment there is an interconnect system for circuit card assemblies including first and second circuit card assemblies, each having an edge connector including a set of resilient, spaced, conductive contacts electrically isolated from each other and extending from a surface of and over an edge of each card assembly; and a connector card interposed between the edge connectors and having a set of connector contacts on each face for engaging corresponding sets of contacts on each of the circuit card assemblies.

In preferred embodiments each edge connector may include a header for mounting the contacts to the circuit card assembly. The connector card may include a connector apparatus with a positive retention device. The connector apparatus may be configured to mate with a connector on a third circuit card assembly. Each edge connector may carry electronic components on one surface and the contacts may extend from the other surface. Each edge connector may carry electronic components on one surface and the contacts may extend from that surface. The resilient contacts may be curved spring fingers. The circuit card assembly may have a relief for accommodating the spring fingers. The circuit card assemblies may be adjacent and constrained to apply a contact closing force to the contacts.

In another embodiment there is a circuit card assembly connector system including a circuit card assembly and an edge connector including a set of resilient, spaced, conductive contacts electrically isolated from each other and extending from a surface of and over an edge of the circuit card assembly.

In preferred embodiments the edge connector may include a header for mounting the contacts to the circuit card assembly. Each circuit card assembly may carry electronic components on one surface and the contacts may extend from the other surface. Each circuit card assembly may carry electronic components on one surface and the contacts may extend from the that surface. The contacts may be curved spring fingers. The circuit card assembly may have a relief for accommodating the spring fingers.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a three dimensional, exploded, diagrammatic view of panel array with daughter cards using a connector and interconnection system according to one embodiment;

FIG. 2 is an enlarged view of a portion of showing the connector in more detail;

FIG. 3 is a schematic, side elevational view of the edges of two circuit card assemblies or daughter boards and their cooperating connectors;

FIG. 4 is a three dimensional view showing the full complement of eight daughter boards mounted on the panel array;

FIG. 5 is a schematic, side, sectional, elevational view of the interconnection system with two adjacent connectors and an interstitial connector board;

FIG. 6 is a three dimensional diagrammatic view of a plurality of contacts implemented with resilient fingers and mounted to a header;

FIG. 7 is a diagrammatic side sectional view of the contracts and header of FIG. 6;

FIG. 8 is a three dimensional schematic view of a connector board;

FIG. 9 is another implementation of the interconnection system without a connector board or recesses in the circuit board assembly edges;

FIG. 10 is another implementation of the interconnection system similar to FIG. 9 with the headers on the top, component surface;

FIG. 11 is another implementation of the interconnection system similar to FIG. 10 without headers; and

FIG. 12 is another implementation of the interconnection system similar to FIGS. 10 and 11 with only one circuit card assembly having a connector of the type shown here and the other having conventional contact pads.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

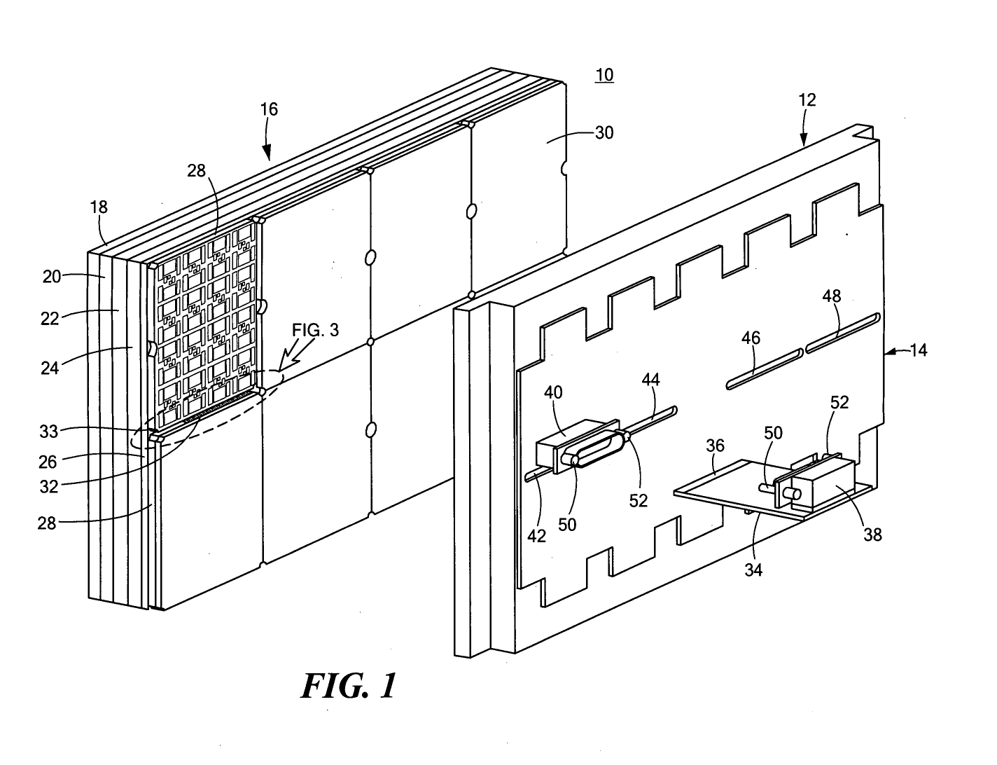

There is shown in FIG. 1 a panel array 10 such as for a phased array radar system. The panel array includes a brazement 12 which carries a card 14 that may be a back plane or a power and/or a logic board. Panel array 10 also includes a panel 16 including a radar radiator 18, a first circulator 20, a mother board 22 and a second circulator 24 if this is to serve a dual polarity phased radar system. There is also an interposer board 26 which may serve for a fuzz button (or CIN::APSE buttons) connection between the circuit board assemblies such as daughter boards 28 and the panel 16. A thermal spreader 30 is disposed between brazement 12 and daughter boards 28. Each daughter board or circuit card assembly 28 includes a connector 32 along one edge 33 of card assembly 28. In the embodiment shown in FIG. 1 brazement 12 and panel 16 with thermal spreader 30 are brought together and a connection from back plane or power and/or logic board 14 is made to the connectors 32 on circuit card assembly 28 by means of connector board 34 which has contacts 36 on both sides and carries one half of a connector 38; the other half of the connector 40 is mounted on board 14. Connector board 34 is inserted into slot 42 with zero panel insertion force and is interjected between connectors 32 on adjacent circuit card assembles 28. There are three other slots 44, 46, and 48 which accommodate cards (not shown) similar to cards 34 carrying connector portions similar to connector 38 which engages with a mating connector similar to connector 40 mounted on board 14. Connector portions 38 and 40 mate and have a positive retention device such as clamps, spring latches, or screws and receivers as shown at 50 and 52. In this way connector 32 utilizes unusable space between the daughter cards or circuit card assemblies 28. There are no additional perforations and the thermal spreader benefits from very few perforations for the connection cards 34.

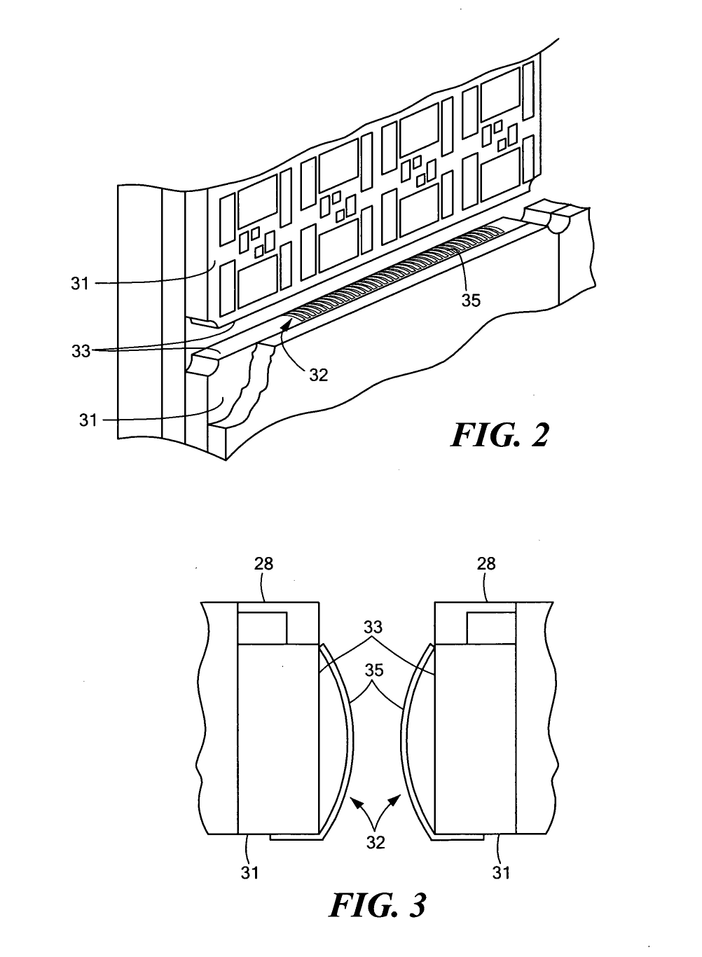

Each connector 32 on an edge 33 FIG. 2 of circuit card assemblies 28, includes a number or set of contacts, one set on the edge of each circuit card assembly 28 which may be, as shown, resilient, spaced conductors 35 electrically isolated from each other and extending from a surface 31 over an edge 33 of each circuit card assembly 28. The edges 33 of circuit card assemblies 28 and the conductors 35 are shown in side view in FIG. 3.

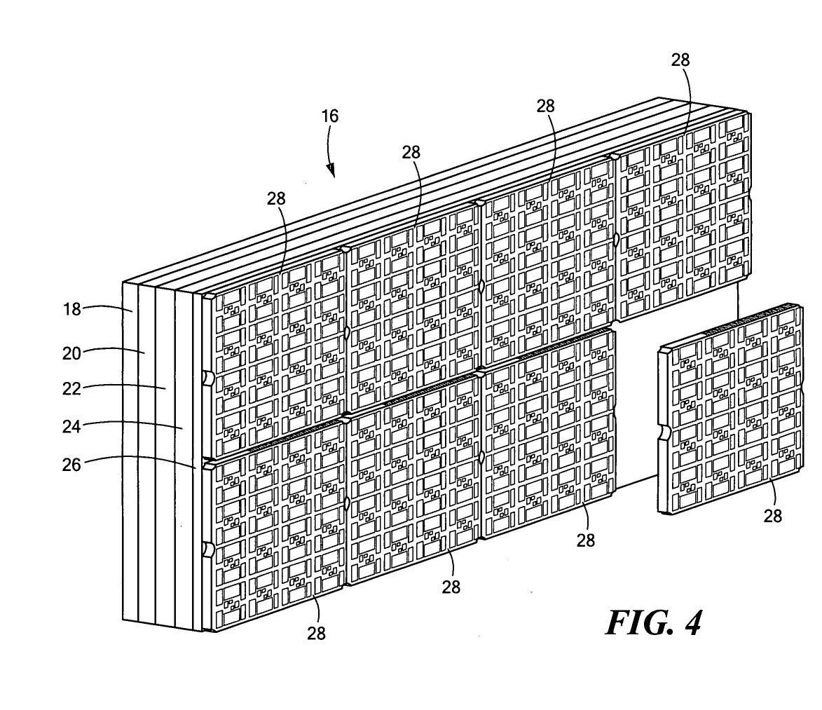

In this particular embodiment there are actually eight daughter boards 28, FIG. 4, each of which includes sixteen cells or elements each one of which may contain a number of monolithic microwave integrated circuits (MMIC).

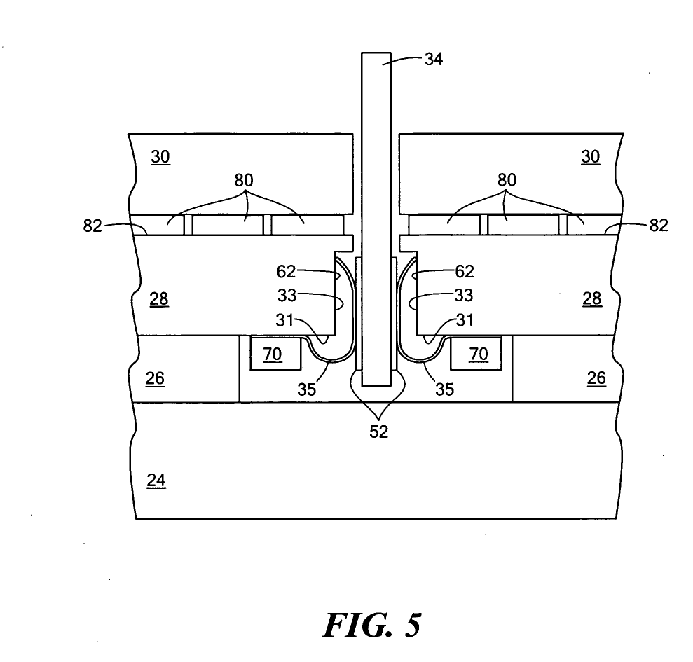

The interconnection system using two connectors is shown enlarged and in more detail in FIG. 5 where connector card 34 with contacts 52 passes between the sections of spreader 30 between circuit card assemblies or daughter cards 28 where it engages with the connector 32, in this case, having a set of contacts (e.g., springs) 35 on the edges 33 of circuit card assemblies 28. Resilient spring fingers 35 in FIG. 5 extend from one surface 31 of circuit card assemblies 28 over the edge 33. In FIG. 5 circuit card assemblies 28 have been relieved or recessed as at 62 to provide a space for protection for springs 35. Connector 32 may also include a header or header block 70 which anchors the set of contacts implemented by spring fingers 35 to circuit card assemblies 28. Note that the springs 35 and their associated header or header blocks 70 are disposed on the bottom surface of circuit card assemblies 28, that is, the surface that has no components mounted on it. The components 80 in this case are mounted on the top surface 82 of circuit card assemblies 28.

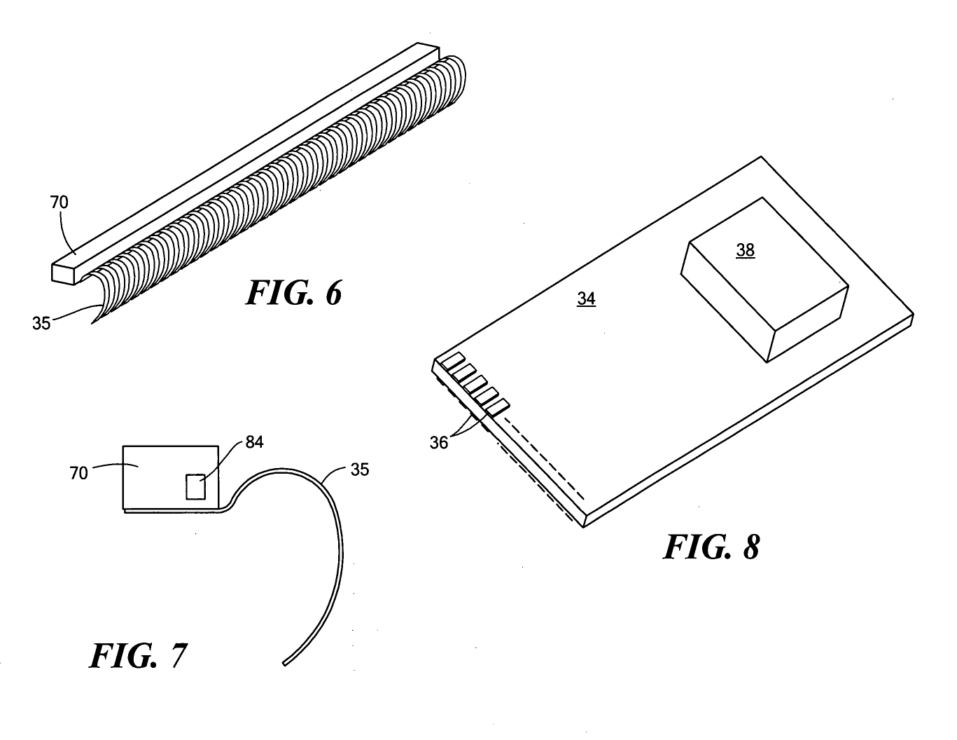

A view of a full connector 32 is shown in FIG. 6 including both the resilient spring fingers 35 and a header block 70. Although thus far these spring fingers have been shown in the particular curved shape where they extend over the edge, this is not a necessary limitation as other functional shapes can be used. Furthermore, although the spring fingers 35 are shown as equally spaced and equal in width neither of these are strict limitations. They may vary in size or a number of them may be combined for example and the spacing need not be uniform.

For automated pick and place fabrication techniques when a header or header block 70 is used, FIG. 7, it is convenient to position the center of gravity 84 such that when the combination header 70 and fingers 35 are picked and placed on the surface of the circuit card assembly near the edge, the header block 70 and fingers 35 remain stable and do not tip prior to or during the soldering process. Connector board 34 has a plurality of contacts 36 on either or both sides as shown in FIG. 8 which contacts interconnect through conductors (not shown) in the body of connector board 34 to the connector 38.

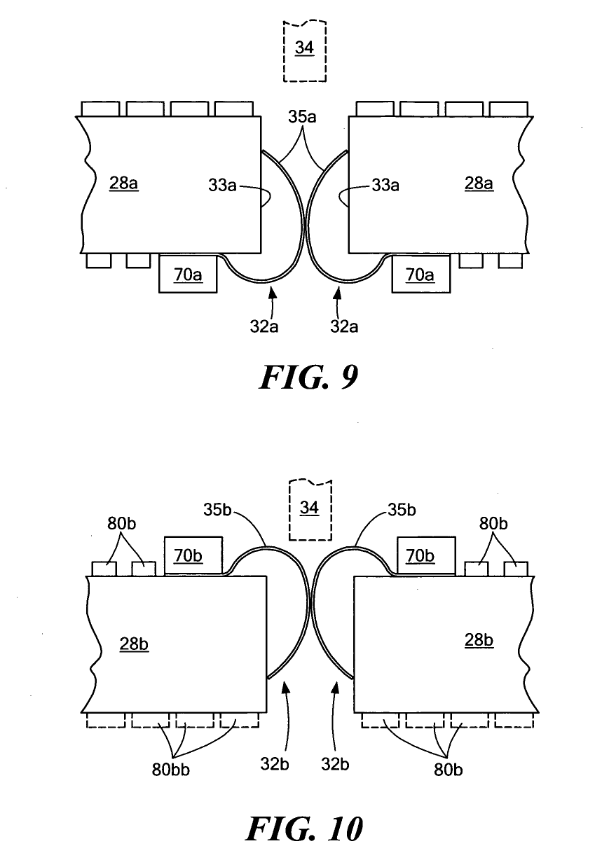

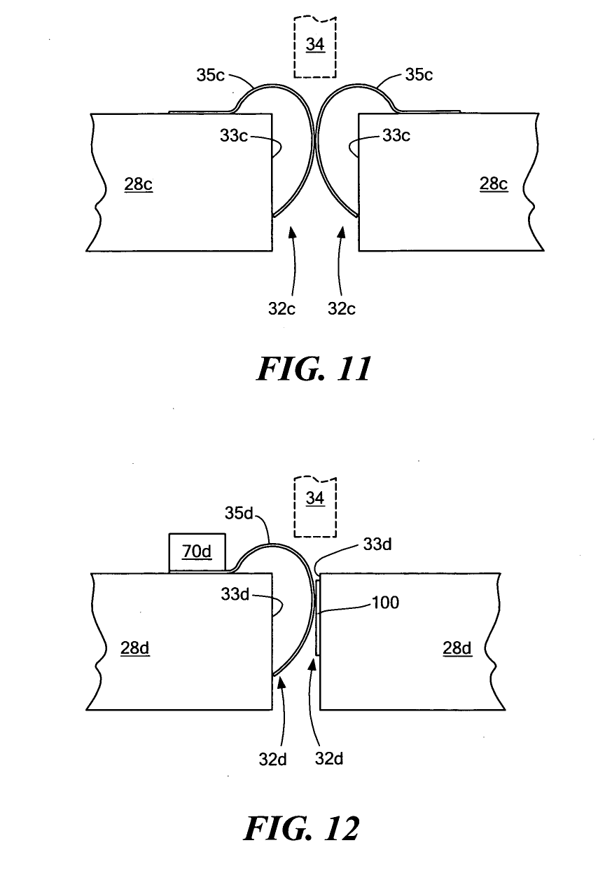

Although thus far the connector and interconnection system has been shown with resilient springs on the edge of two adjacent circuit card assemblies with an interposed connector card between them this is not a necessary limitation of the invention. For example, in FIG. 9, circuit card assemblies 28a have their resilient springs 35a of their connectors 32a interconnecting directly without the use of a connector card 34 shown only in phantom to indicate its absence in FIG. 9. Also in FIG. 9 there is no recess or relief provided for springs 35a. In order to conserve the area reserved for components the connector including resilient springs 35a and header block 70a have been mounted on the surface that does not contain the components herein nominally referred to as the bottom surface, but this is not a necessary limitation of the invention. For example, as shown in FIG. 10, the header block 70a and resilient springs contacts 35a may be mounted on the same side as the components 80a if there is sufficient room. There may as well be components 80bb on the other or bottom side as well. FIG. 11 illustrates that resilient fingers 35c may be used if desired without header blocks. With or without header blocks 70d, FIG. 12 illustrates that only one of the connectors 32d may include the resilient spring fingers 35d that extend from the a surface over edge 33d. The adjacent circuit card assembly may include a set of contacts 32a which are simply contact pads 100 on edge 33.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. An interconnection system for circuit card assemblies comprising:
at least first and second circuit card assemblies, said first one having an edge connector including a set of resilient, spaced, conductive contacts electrically isolated from each other and extending from a surface of said first circuit card assembly and over the edge of the said first circuit card assembly disposed opposite to a second set of conductive contacts on the edge of said second circuit card assembly.

2. The interconnection system of claim 1 in which said edge connector includes a header for mounting said contacts to said circuit card assembly.

3. The interconnection system of claim 1 in which said contacts of one said circuit card assembly directly interconnect with the said contacts of the other said circuit card assembly.

4. The interconnection system of claim 1 further comprising a connector card interposed between said circuit card assemblies which interconnects with said contacts of each of said circuit card assemblies.

5. The interconnection system of claim 1 in which said connector card includes a connector apparatus with a positive retention device.

6. The interconnection system of claim 1 in which each said first circuit card assembly carries electronic components on one surface and said contacts extend from the other surface.

7. The interconnection system of claim 1 in which each said first circuit card assembly carries electronic components on one surface and said contacts extend from that surface.

8. The interconnection system of claim 1 in which said first set of contacts are curved spring fingers.

9. The interconnection system of claim 8 in which said first circuit card assembly has a relief for accommodating said spring fingers.

10. The interconnection system of claim 8 in which said second set of contacts are curved spring fingers.

11. The interconnection system of claim 1 in which said circuit card assemblies are adjacent and constrained to apply a contact closing force to said contacts.

12. An interconnect system for circuit card assemblies comprising:
first and second circuit card assemblies, each having an edge connector including a set of resilient, spaced, conductive contacts electrically isolated from each other and extending from a surface of and over an edge of each card assembly; and
a connector card interposed between said edge connectors and having a set of connector contacts on each face for engaging corresponding sets of contacts on each of said circuit card assemblies.

13. The interconnection system of claim 12 in which each said edge connector includes a header for mounting said contacts to said circuit card assembly.

14. The interconnection system of claim 12 in which said connector card includes a connector apparatus with a positive retention device.

15. The interconnection system of claim 14 in which said connector apparatus is configured to mate with a connector on a third circuit card assembly.

16. The interconnection system of claim 12 in which each said edge connector carries electronic components on one surface and said contacts extend from the other surface.

17. The interconnection system of claim 12 in which each said edge connector carries electronic components on one surface and said contacts extend from that surface.

18. The interconnection system of claim 12 in which said resilient contacts are curved spring fingers.

19. The interconnection system of claim 18 in which said circuit card assembly has a relief for accommodating said spring fingers.

20. The interconnection system of claim 12 in which said circuit card assemblies are adjacent and constrained to apply a contact closing force to said contacts.

21. A circuit card assembly connector system comprising:
a circuit card assembly; and
an edge connector including a set of resilient, spaced, conductive contacts electrically isolated from each other and extending from a surface of and over an edge of said circuit card assembly.

22. The connector system of claim 21 in which said edge connector includes a header for mounting said contacts to said circuit card assembly.

23. The connector system of claim 21 in which each said circuit card assembly carries electronic components on one surface and said contacts extend from the other surface.

24. The connector system of claim 21 in which each said circuit card assembly carries electronic components on one surface and said contacts extend from the that surface.

25. The connector system of claim 21 in which said contacts are curved spring fingers.

26. The connector system of claim 25 in which said circuit card assembly has a relief for accommodating said spring fingers.
